(19) United States
(12) Patent Application Publication
(10) Pub. No.: US 2015/0090622 A1
(43) Pub. Date: Apr. 2, 2015

(54) Pouchkin

(71) Applicant: Erin L. Bassi, Overland Park, KS (US)

(72) Inventor: Erin L. Bassi, Overland Park, KS (US)

(21) Appl. No.: 14/042,915

(22) Filed: Oct. 1, 2013

(51) Int. Cl. A47J 47/02; B65D 77/04; B65D 85/60

(52) U.S. Cl. CPC A47J 47/02; B65D 85/60; B65D 77/0473
USPC 206/457

(57) ABSTRACT

Pouchkin is a device used for enabling a user to house prepackaged foodstuff pouches, such as applesauce or other relatively soft food product. The Pouchkin device includes a housing having an internal compartment for the insertion of the prepackaged foodstuff pouch. One end of the housing is formed with one or more openings for the insertion of the prepackaged foodstuff pouch. The Pouchkin device is constructed such that the prepackaged foodstuff pouch may be inserted into the housing thereby allowing the user to open the foodstuff pouch and consume while foodstuff pouch is securely inside the housing. In many of the later described preferred embodiments, the shape of the housing may take on many shapes, such as that of a toy shape making the Pouchkin exceptionally attractive to children.

### OBJECT AND BRIEF SUMMARY OF INVENTION

An object of the invention is to conveniently enable the user, such as a child, to consume a foodstuff pouch without the opportunity to oversqueeze such foodstuff.

One characteristic of the invention, there is a housing having an internal compartment for the insertion of a foodstuff pouch; one end of said housing being closed by an end wall, fashioned with at least one opening for prepackaged foodstuff pouch to be consumed; said housing being produced with a whimsical nature so as to be exceptionally attractive to children. Housing shall have a flat base to stably sit on a horizontal surface, cup holder, or the like. One end of housing may be detachable so as for ease of insertion of foodstuff pouch.

Another characteristic of the invention, there is a housing having an internal compartment for the insertion of a foodstuff pouch; one end of said housing being closed by an end wall, fashioned with at least one non-detachable opening for prepackaged foodstuff pouch to be consumed; said housing being produced with a whimsical nature so as to be exceptionally attractive to children. Housing shall have a flat base to stably sit on a horizontal surface, cup holder, or the like.

Another characteristic of the invention, there is a housing having an internal compartment for the insertion of a foodstuff pouch; one end of said housing being closed by an end wall, fashioned with at least one opening for prepackaged foodstuff pouch to be consumed; said housing being produced with a whimsical nature so as to be exceptionally attractive to children. Housing shall have a flat base to stably sit on a horizontal surface, cup holder, or the like. One end of housing may or may not be detachable so as for ease of insertion of foodstuff pouch. And the housing may be shaped so as for handles to be utilized.

Further designs and evident features of the invention will readily be shown in the descriptions that follow.

### BRIEF DESCRIPTIONS OF THE DRAWINGS

The invention is hereby further described by way of example purposes by referring to the following drawings. In reference to the drawings, it is intended to make evident that the particulars exposed are of examples of the use of principles and conceptual aspects of the invention. The structural details are in no way exemplary of anything more than necessity for the fundamental understanding of the invention.

In the drawings:

FIG. 1 illustrates one form of the invention constructed in accordance with the device as described above;

FIG. 2 is a constructive sectional view illustrating the invention of FIG. 1;

FIG. 3 illustrates a further form of the invention constructed in accordance with the device as described above;

FIG. 4 is a constructive sectional view illustrating the invention of FIG. 3;

FIG. 5 illustrates a further form of the invention constructed in accordance with the device as described above. In addition, FIG. 5 illustrates an example of a foodstuff pouch as referenced to frequently;

FIG. 6 is a constructive sectional view illustrating the invention of FIG. 5.

### DESCRIPTION OF PREFERRED EMBODIMENTS

As indicated previously, the invention is a device used for enabling a user to house prepackaged foodstuff pouches, such as applesauce or other relatively soft food product. The Pouchkin device includes a housing having an internal compartment for the insertion of the prepackaged foodstuff pouch. One end of the housing is formed with one or more openings for the insertion of the prepackaged foodstuff pouch. The Pouchkin device is constructed such that the prepackaged foodstuff pouch may be inserted into the housing thereby allowing the opening to enable the user to open the foodstuff pouch and consume while foodstuff pouch is securely inside the housing.

The drawings illustrate a variety of such construction of the device useful for foodstuff pouches.

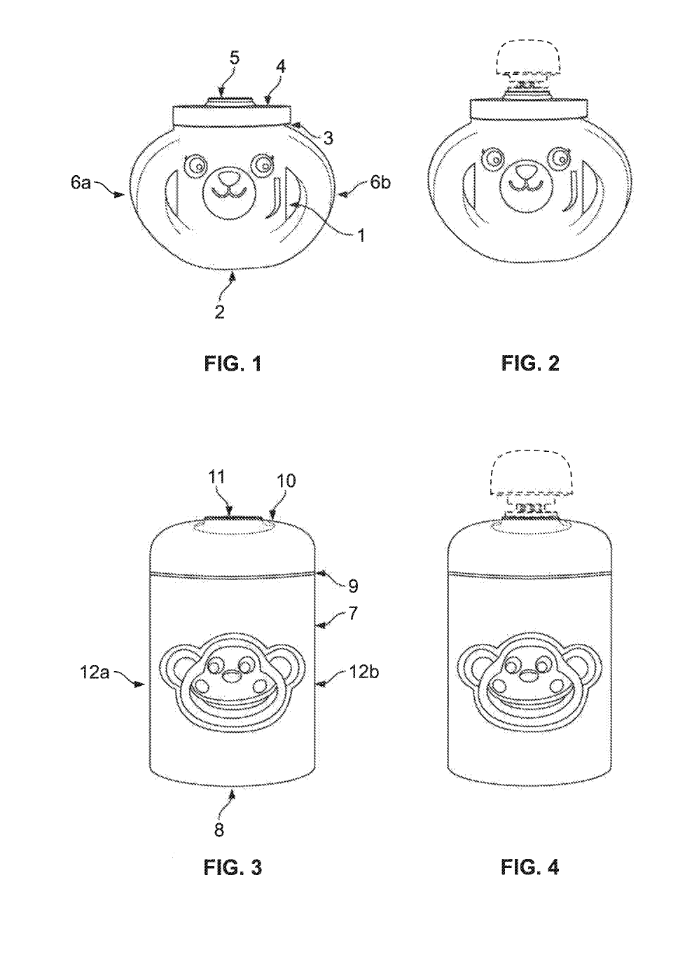

The invention illustrated in FIGS. 1 and 2 includes a housing 1 enabling an internal compartment for containing a foodstuff pouch. One end of housing 1 is closed by an end wall 2 formed seamlessly as design of the housing. End wall 3 is formed with an opening for which lid 4 may be attached. Lid 4 encompasses an opening 5 whereby nipple of foodstuff pouch may be visible and dispensable to user. Left 6a and right 6b vertical side of housing 1 encompass handle design for ease of use by user.

Therefore it can be seen when lid 4 is removed from housing 1 end wall 3 is exposed and the foodstuff pouch can then be placed into housing 1. The lid 4 would then be replaced back onto the housing 1 whereby on end wall 3 securing foodstuff pouch within housing and nipple of foodstuff pouch exposed.

The device illustrated in FIGS. 1 and 2 can be constructed so as to be a one-time use device or a multiple use device.

FIGS. 3 and 4 show a device very similar to those described above with respect to FIGS. 1 and 2, except the housing, designated as 7, is constructed without the seamless handle design.

FIGS. 3 and 4 show a device constructed similar to those described above with respect to FIGS. 1 and 2. Thus housing 7 enabling an internal compartment for containing a foodstuff pouch. One end of housing 7 is closed by an end wall 8 formed seamlessly as design of the housing 7. End wall 9 is formed with an opening for which lid 10 may be attached. Lid 10 encompasses an opening 11 whereby nipple of foodstuff pouch may be visible and dispensable to user. Right 12a and left 12b vertical side of housing 7 is a seamless design of closed walls.

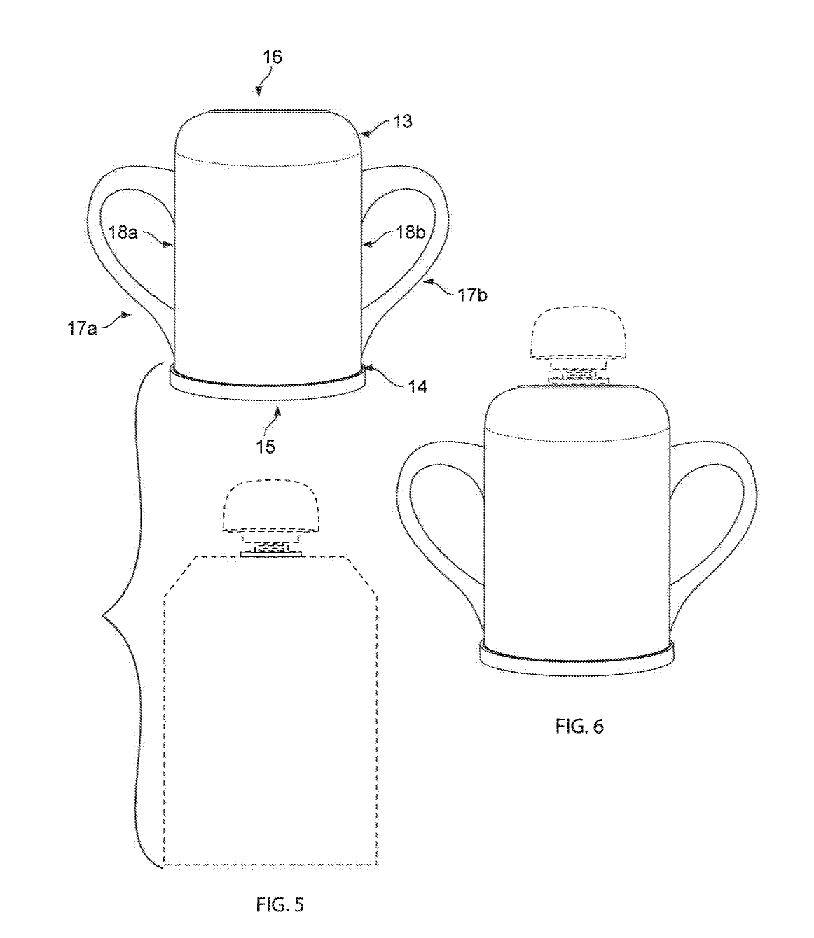

FIGS. 5 and 6 show a device very similar to those described above with respect to FIGS. 1 and 2, except the housing, designated as 13, is constructed with a left 17a and right 17b handle design that is not seamless. In addition, the bottom end wall 14 is formed with an opening whereby lid 15 is attached.

FIGS. 5 and 6 show a device constructed similar to those described above with respect to FIGS. 1 and 2. Thus housing 13 enabling an internal compartment for containing a foodstuff pouch. The bottom end of housing 14 is formed with an opening whereby lid 15 is attached. End wall 16 is formed with an opening whereby nipple of foodstuff pouch may be visible and dispensable to user. Housing 13 is constructed with a left 17a and right 17b handle design that is not seamless with respect to housing 13. Right 18a and left 18b vertical side of housing 13 is a seamless design of closed walls.

The dotted drawing in FIG. 5 is an example of a foodstuff pouch referenced hereby throughout, and thus example of such foodstuff pouch inserted into described housing.

The device has been described in conjunction with specific embodiments above, however it must be noted that many variations and modifications are apparent to those skilled in the art. For example, the device may take many toy designs, colors and shapes. Therefore it is intended to encompass all such device alternatives, variations and modifications that fall within the broad scope of the aforementioned claims.

What is claimed is:

1. A device for enabling a user to consume a prepackaged foodstuff pouch, comprising: a housing having an internal compartment for the insertion of a foodstuff pouch; one end of said housing being closed by an end wall, fashioned with at least one opening for prepackaged foodstuff pouch to be consumed; said housing being produced with a whimsical nature so as to be exceptionally attractive to children. Housing shall have a flat base to stably sit on a horizontal surface, cup holder, or the like. One end of housing may be detachable so as for ease of insertion of foodstuff pouch.

2. The device, in accordance with claim 1, wherein described housing includes: a non-detachable end whereby foodstuff pouch may be freely inserted into end wall containing said opening.

3. The device, in accordance with claim 1 and claim 2, wherein said housing may or may not include: handles for ease of usability.

4. The device, in accordance to claim 1 and claim 2 and claim 3, may or may not be reusable so as to remove and discard emptied foodstuff pouch, and replace with another foodstuff pouch.
